(19) United States
(12) Patent Application Publication
(10) Pub. No.: US 2016/0169463 A1
(43) Pub. Date: Jun. 16, 2016

(54) LAMP WITH INTERNAL PROJECTION

(71) Applicant: TARGET BRANDS, INC., Minneapolis, MN (US)

(72) Inventors: Jennifer GUNDERSON, St. Paul, MN (US); Arthur C. KEGEL, Chaska, MN (US)

(73) Assignee: TARGET BRANDS, INC., Minneapolis, MN (US)

(21) Appl. No.: 14/570,522

(22) Filed: Dec. 15, 2014

(51) Int. Cl. F21S 6/00; F21S 9/02

(52) U.S. Cl. CPC F21S 6/00; F21S 9/02; F21Y 2101/02

(57) ABSTRACT

A lamp includes a housing, an object, and an electrical assembly. The housing includes a bottom panel and a sidewall extending upwardly away from the bottom panel to define a chamber within the housing. The sidewall includes a projection portion extending away from the bottom panel. The object is statically coupled to the bottom panel. The object is spaced from the projection portion and is enclosed within the chamber. The electrical assembly is mounted on the bottom panel within the chamber. The electrical assembly includes a light source. When the light source is illuminated, light rays from the light source are directed toward the projection portion of the sidewall, and a portion of the light rays are blocked by the object creating a shadow on the projection portion of the sidewall. The shadow is visible through the sidewall when viewing the lamp from a location external to the chamber.

### BACKGROUND OF THE INVENTION

Various lamp designs exist for use to provide a low degree of lighting and/or to otherwise serve as a nightlight. The complexity of such lamp designs varies a great deal from a simple bulb supporting structure that plugs into and is supported by an electrical outlet to animated light displays. The demand for lighting a child's room at night has remained strong over the years. While simple structures provide light, they often lack meaningful visual appeal to children. More complicated lamps, such as lamps with moving light presentations provide light and interest to a child, but may be undesirably over stimulating to children preparing for sleep. As such, a need continues for lamps that provide a proper level of aesthetic interest, a low level of ambient lighting, and use a fairly simple construction to maintain an acceptable price point for retail sale.

### SUMMARY OF THE INVENTION

One aspect of the present invention relates to a lamp including a housing, a subject object, and an electrical assembly. The housing includes a bottom panel and a sidewall extending upwardly away from the bottom panel to collectively define a chamber substantially enclosed within the housing. The sidewall includes a projection portion extending away from the bottom panel and having a first height. The object is statically coupled to and extends upwardly from the bottom panel. The object is spaced from the projection portion of the sidewall and is enclosed within the chamber. The electrical assembly is mounted on the bottom panel and maintained within the chamber. The electrical assembly includes a light source positioned on a side of the object opposite the projection portion of the sidewall. When the light source is illuminated, light rays from the light source are directed toward the projection portion of the sidewall, and a portion of the light rays are blocked by the object creating a shadow on the projection portion of the sidewall. The shadow is visible through the sidewall when viewing the lamp from a location external to the chamber. Other apparatus, assemblies, and associated methods are also disclosed.

### BRIEF DESCRIPTION OF THE DRAWINGS

Embodiments of the invention will be described with respect to the figures, in which like reference numerals denote like elements, and in which:

FIG. 1 is a front perspective view illustration of a non-illuminated lamp, according to one embodiment of the present invention.

FIG. 2 is a front view of the lamp of FIG. 1, according to one embodiment of the present invention.

FIG. 3 is a rear view of the lamp of FIG. 1, according to one embodiment of the present invention.

FIG. 4 is a right side view of the lamp of FIG. 1, according to one embodiment of the present invention, wherein the left side view of the lamp is a mirror image of the left side view.

FIG. 5 is a top view of the lamp of FIG. 1, according to one embodiment of the present invention.

FIG. 6 is a bottom view of the lamp of FIG. 1, according to one embodiment of the present invention.

FIG. 7 is a front perspective view illustration of the lamp of FIG. 1 when illuminated, according to one embodiment of the present invention.

FIG. 8 is a front view of the lamp of FIG. 7, according to one embodiment of the present invention.

FIG. 9 is a rear view of the lamp of FIG. 7, according to one embodiment of the present invention.

FIG. 10 is a right side view of the lamp of FIG. 7, according to one embodiment of the present invention, wherein the left side view of the lamp is a mirror image of the left side view.

FIG. 11 is a top view of the lamp of FIG. 7, according to one embodiment of the present invention.

FIG. 12 is a bottom view of the lamp of FIG. 7, according to one embodiment of the present invention.

FIG. 13 is a partially exploded, front perspective view illustration of the lamp of FIG. 1 with a partial cutaway of the housing, according to one embodiment of the present invention.

FIG. 14 is a front, perspective view illustration of an opaque object of the lamp of FIG. 13, according to one embodiment of the invention.

FIG. 15 is a cross-sectional view illustration of the illuminated lamp of FIG. 7 taken along lines X-X of FIG. 8, according to one embodiment of the present invention.

FIG. 16 is a front perspective view illustration of a non-illuminated lamp, according to one embodiment of the present invention.

FIG. 17 is a front view of the lamp of FIG. 16, according to one embodiment of the present invention.

FIG. 18 is a rear view of the lamp of FIG. 16, according to one embodiment of the present invention.

FIG. 19 is a right side view of the lamp of FIG. 16, according to one embodiment of the present invention, wherein the left side view of the lamp is a mirror image of the left side view.

FIG. 20 is a top view of the lamp of FIG. 16, according to one embodiment of the present invention.

FIG. 21 is a bottom view of the lamp of FIG. 16, according to one embodiment of the present invention.

FIG. 22 is a front perspective view illustration of the lamp of FIG. 16 when illuminated, according to one embodiment of the present invention.

FIG. 23 is a front view of the lamp of FIG. 22, according to one embodiment of the present invention.

FIG. 24 is a rear view of the lamp of FIG. 16, according to one embodiment of the present invention.

FIG. 25 is a right side view of the lamp of FIG. 16, according to one embodiment of the present invention.

FIG. 26 is a left side view of the lamp of FIG. 16, according to one embodiment of the present invention.

FIG. 27 is a top view illustration of the lamp of FIG. 16, according to one embodiment of the present invention.

FIG. 28 is a bottom view illustration of the lamp of FIG. 16, according to one embodiment of the present invention.

### DETAILED DESCRIPTION

In one embodiment, a lamp is provided and configured to provide a variable appearance in which an internal object is hidden from external view, an a shadow of the internal object is projected onto an outer housing of the lamp, and the shadow is readily externally viewable when the lamp is illuminated. In one example, the object has a shape aesthetically complementing the overall shape of the lamp such that the two shapes collectively form a thematic overall appearance. The object, which children and/or other observers will likely perceive as disappearing when the lamp is not illuminated, provides aesthetic appeal and interest to a child. In one example, the object is stationary within the housing such that the aesthetic appeal of the object does not over stimulate a child preparing for rest and/or sleep.

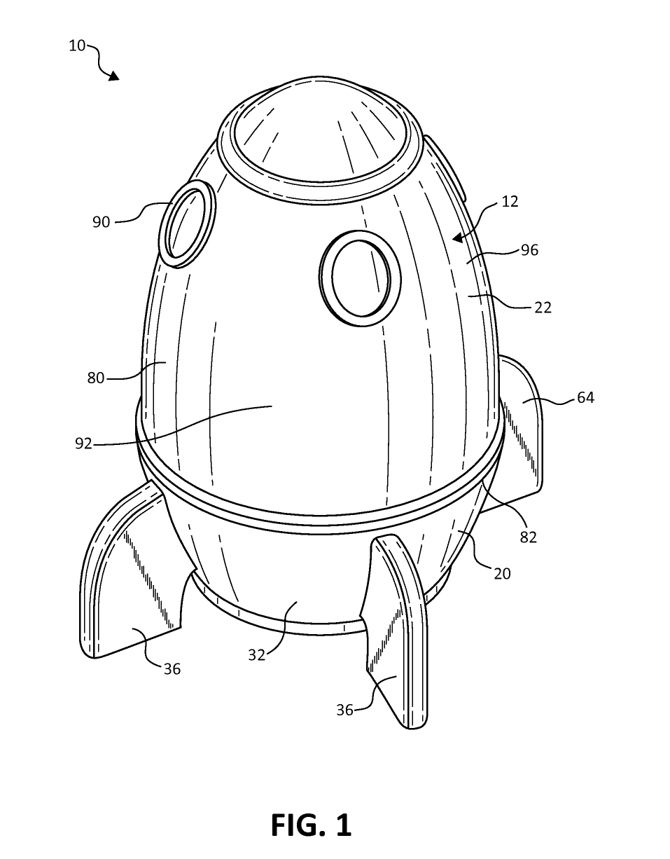

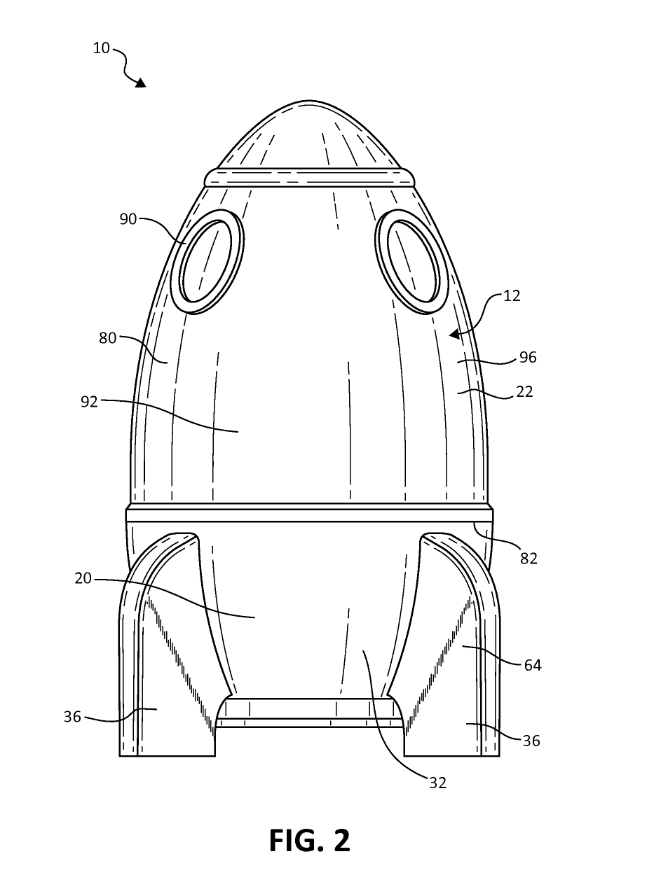

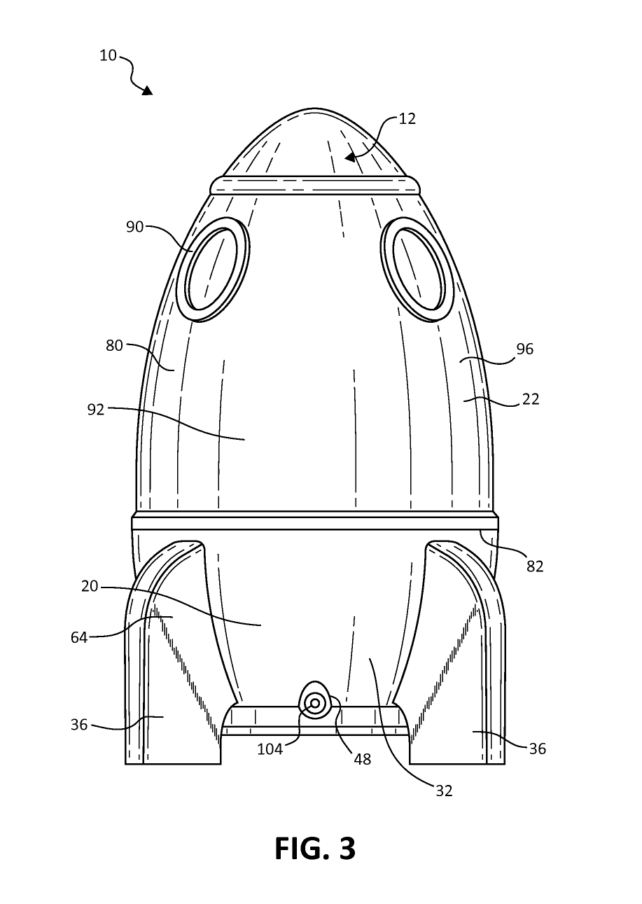

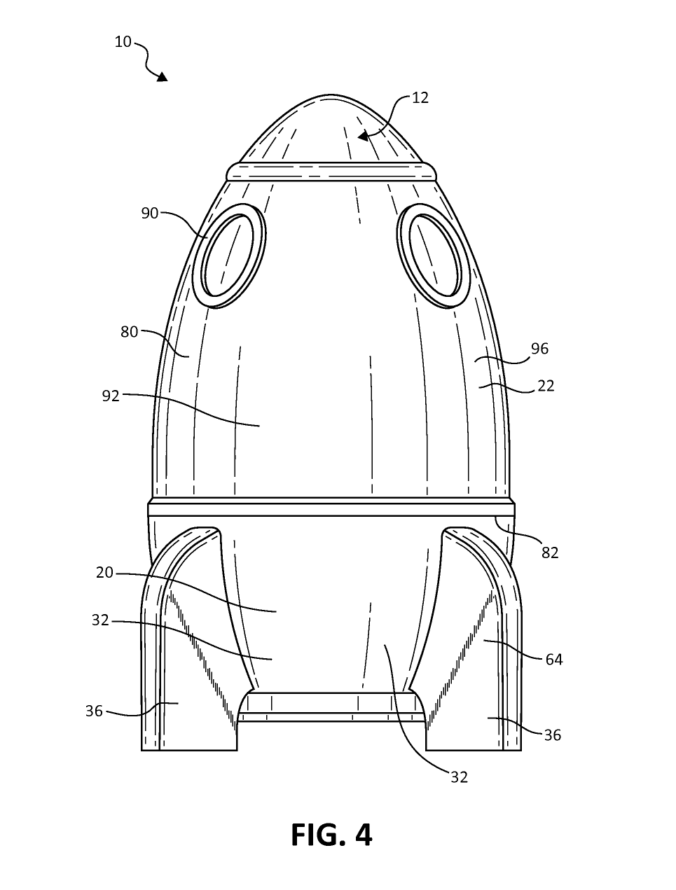

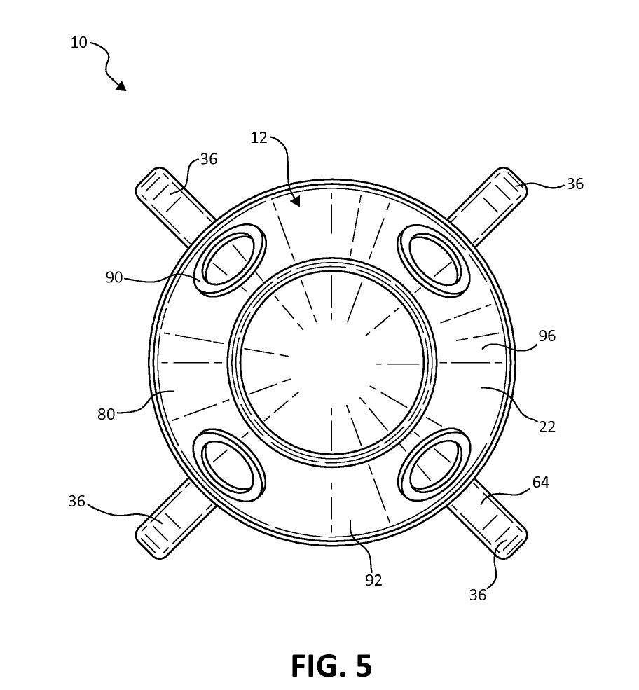

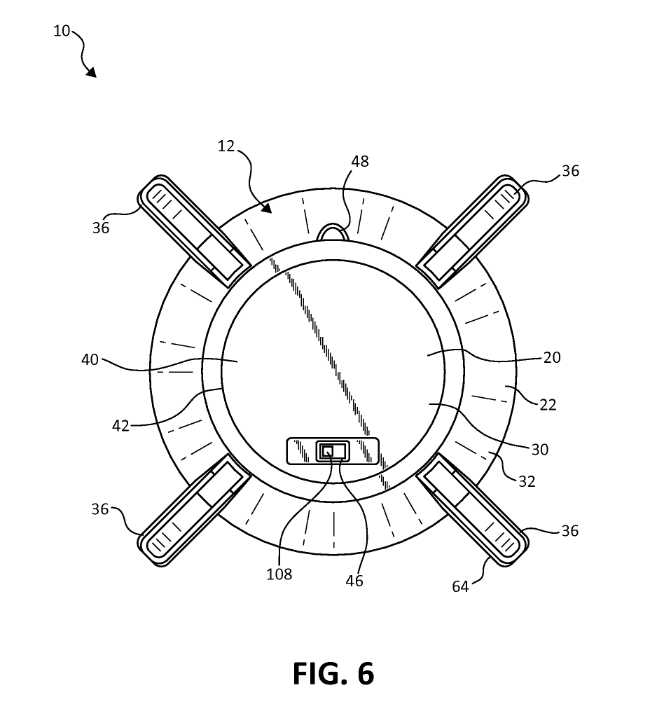

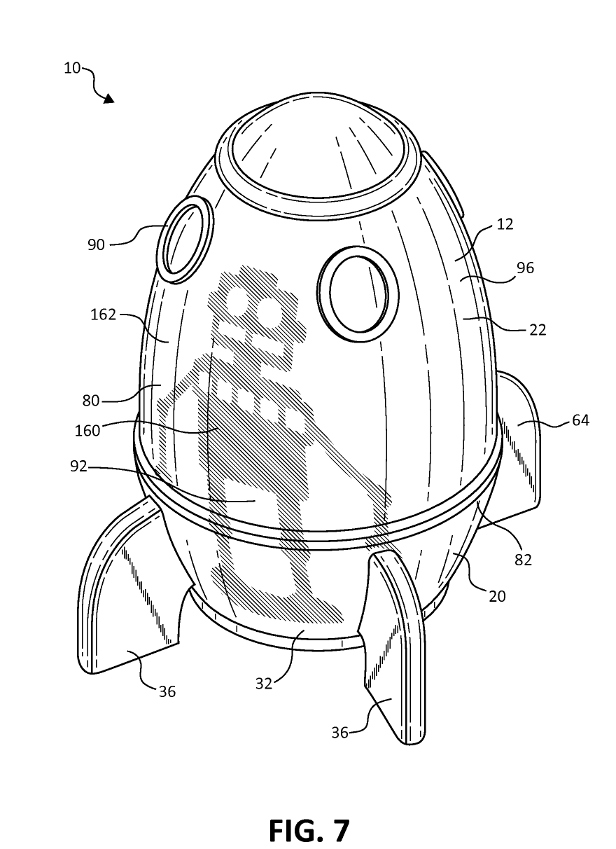

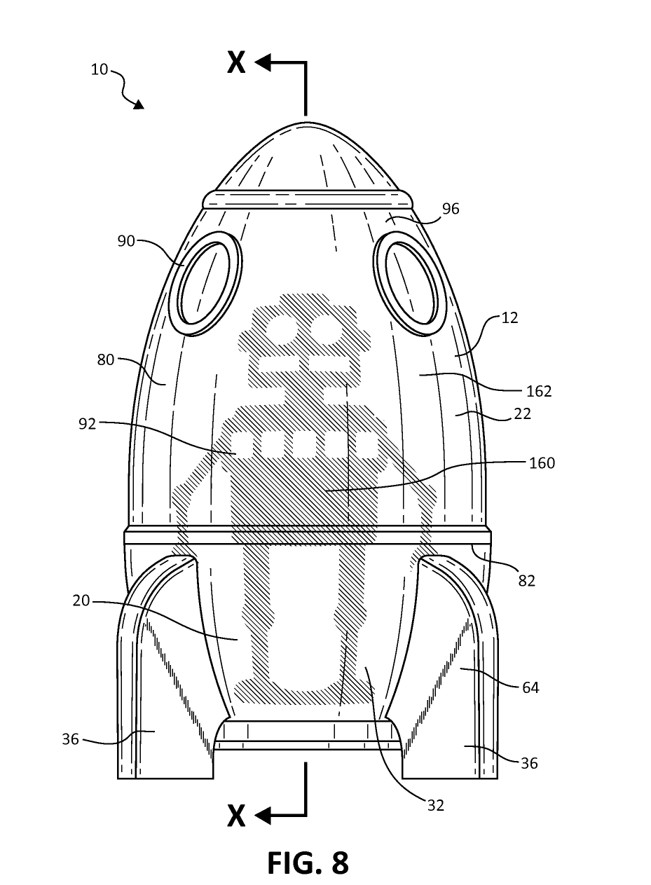

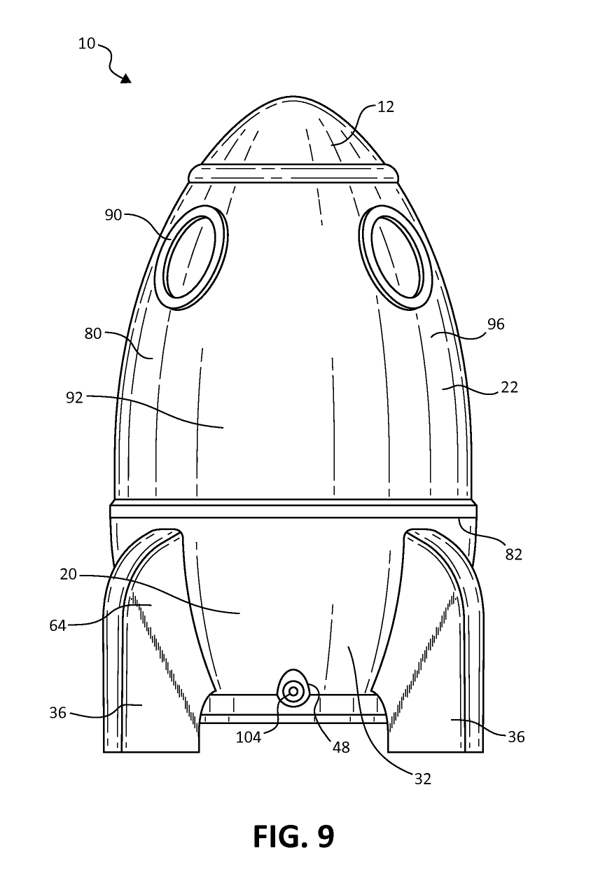

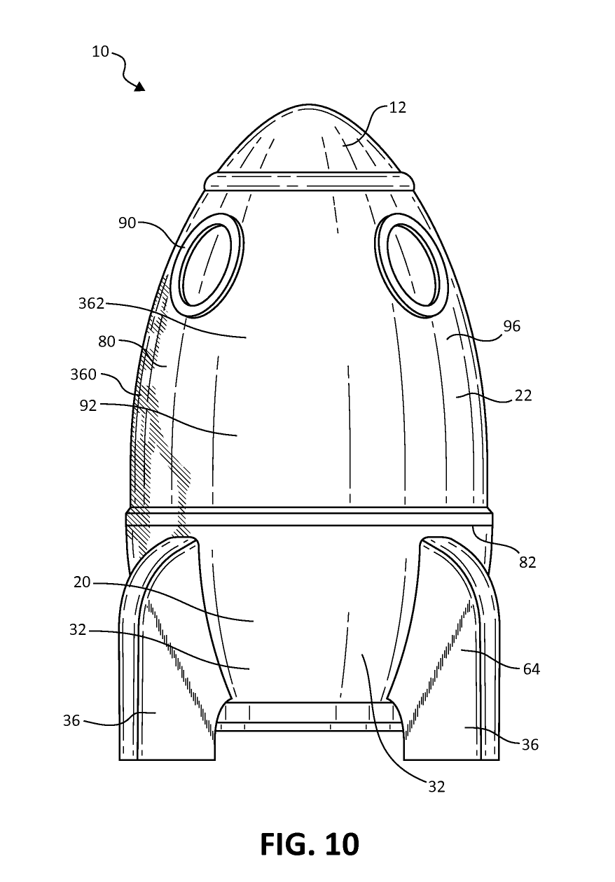

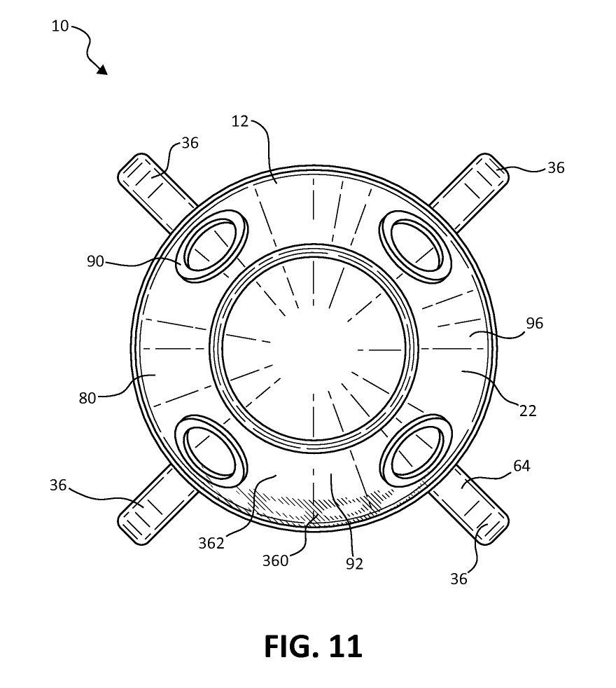

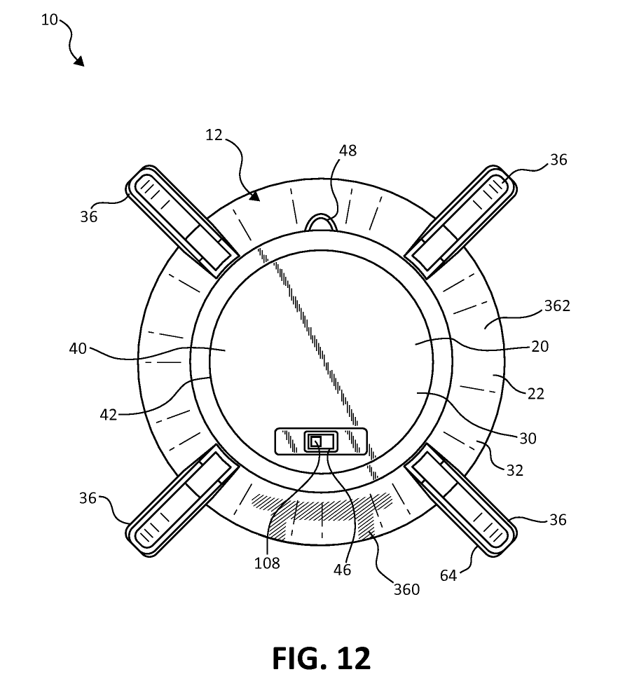

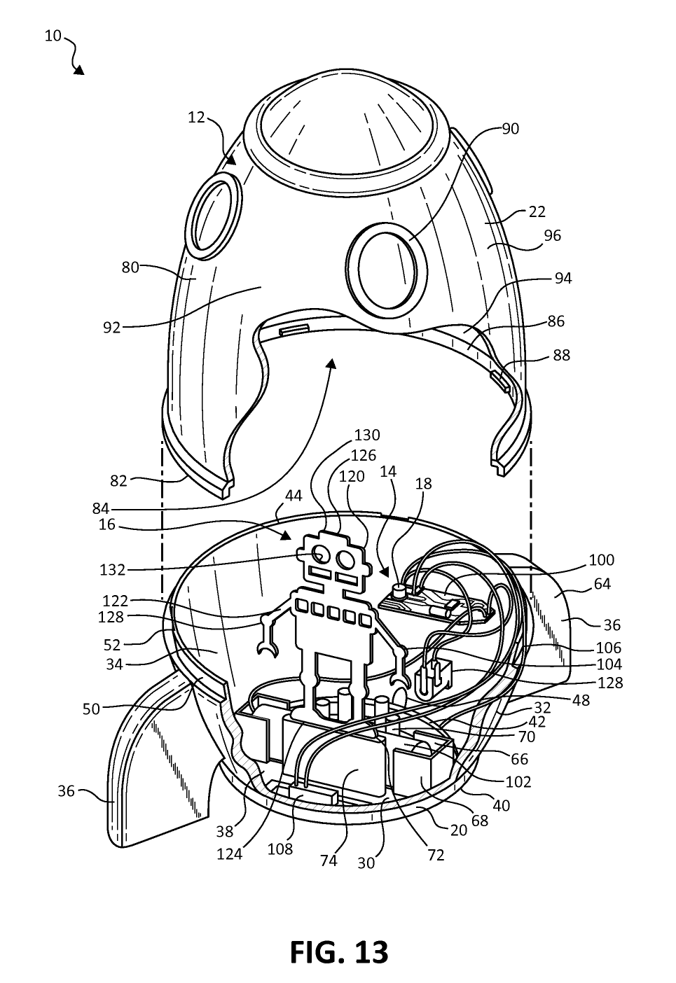

Turning to the figures, one example of a lamp 10 is illustrated in FIGS. 1-13. Lamp 10 includes an enclosure or housing 12, an electrical assembly 14 (see FIG. 13), and an opaque object 16 for projection (see FIG. 13). Electrical assembly 14, which includes a light source 18, and object 16 are both statically maintained within and substantially completely surrounded by, and in example, entirely surrounded by, housing 12. Electrical assembly 14 is positioned relative to object 16 such that rays from light source 18 extending toward a portion of housing 12 are blocked by object 16 in a manner casting a shadow 158 (see FIGS. 7-12) on housing 12. The shadow 158 creates a corresponding dark region 160 (see FIGS. 7-12) visible through housing 12 in the shape of object 16. In this manner, lamp 10 appears to children as presenting a disappearing subject within housing 12, thereby, increasing a child's interest in lamp 10.

In one example, housing 12 includes a first member or base 20 and a second member or cover 22. Base 20 provides a bottom portion of housing 12 that maintains electrical assembly 14 (see FIG. 13), and cover 22 fits over base 20 enclosing electrical assembly 14 within housing 12. Each of base 20 and cover 22 may be formed as a single piece or be collectively formed by a plurality of pieces of a suitable material such as plastic. In one example, base 20 and cover 22 collectively define an overall shape of housing 12 readily identifiable by and configured to provide interest to a child or other observer, such as a rocket ship (as illustrated), an animal, an egg, a character, a star, a heart, a sphere, a flower, a crown, an automobile, a ship, a plane, a planet, a celestial body, a house or other building, etc. While housing 12 has details to be identifiable as a certain overall shape, in one example, such details are limited such that housing 12 provides a substantially smooth projection surface 92 thereof in which dark region 160 will be visible upon use of lamp 10.

As illustrated, base 20 includes a bottom panel 30 and a sidewall 32 extending around and upwardly from a periphery of base 20 to define a base chamber 34 therein, accordingly to one embodiment. Sidewall 32 is substantially, if not entirely, continuous such that base chamber 34 is generally only open at a top side thereof opposite bottom panel 30. In one example, base 20 includes one or more legs 36 holding bottom panel 30 spaced from a supporting surface (not shown), such as a floor, table, or shelf. In the illustrated embodiments, legs 36 are also an aesthetic component of lamp 10, for example, as fins on a rocket ship. In one example, legs 36 are omitted.

Bottom panel 30 is substantially planar and, in one example, defines an interior surface 38 and an exterior surface 40 opposite the interior surface 38. Bottom panel 30 additionally defines a perimeter edge 42 extending between interior surface 38 and exterior surface 40. Sidewall 32 extends from perimeter edge 30 upwardly away from bottom panel 30 to free edge 44. In one example, where bottom panel 30 is circular, sidewall 32 is substantially continuous and curvilinear. In other embodiments, sidewall 32 is substantially continuous, but alternatively formed of a series of planar and or non-planar portions. In yet another example, sidewall 32 is eliminated.

Free edge 44 is configured to selectively receive and couple with cover 22. For example, base 20 defines an internal coupling flange 50 immediately adjacent to free edge 44, and in one embodiment, extending substantially around an entirety of free edge 44. Internal coupling flange 50 is a portion of base 20 that is thinner, for example, between about 30% and about 75% of a thickness of portions of sidewall 32 immediately adjacent internal coupling flange 50. In one embodiment, internal coupling flange 50 partially forms interior surface 38 of base 20, but is inset from exterior surface 40 of base 20. Internal coupling flange 50 additionally includes indentations further limiting the thickness of internal coupling flange 50 and/or apertures forming locking features 52 for mating with corresponding portions of cover 22 as will be further described below. In one example, locking features 52 are L-shaped indentations extending downwardly from free edge 44 and then turning to each extend about a different portion of a circumference of interior coupling flange 50.

In one embodiment, base 20 defines an aperture 46, for example, through bottom panel 30 and/or an opening 48, for instance, at least partially through sidewall 32. Aperture 46 and opening 48 permits access to an interior of base 20, that is to base chamber 34 and/or to electrical assembly 13 mounted therein. Base 20 may include a variety of other features including decorative features 64, a battery reception cavity 66, internal walls 68, one or more placement pegs 70, and/or an object reception slot 72. Decorative features 64 generally are on and/or extend from exterior surface 40 of base 20 and provide additional aesthetic appeal and/or object identification of housing 12. For example, as illustrated, base 20 includes decorative features 64 that also function as feet 36 and are shaped as fins to enhance the overall shape of housing 12 as a rocket ship.

Battery reception cavity 66 is sized and shaped to receive and maintain one or more batteries or first power source 102 within base chamber 34. In one example, internal walls 68 are substantially linear and extend in two directions to define battery reception cavity 66 with a width and length to accommodate first power source 102. Each of placement pegs 70 is an additional or alternative alignment and coupling feature to internal walls 68 to facilitate alignment of portions of electrical assembly 14 with base 20 and/or coupling of portions of electrical assembly to base 20. The arrangement of placement pegs 70 on bottom panel 30 and the distance each placement pegs 70 extends from bottom panel 30 is dependent upon the size and shape of the portion of electrical assembly 14 it will support and/or position.

In one embodiment, base 20 additionally defines a protruding structure 74 extending upwardly from internal surface 38 of bottom panel 30 to define object reception slot 72. Object reception slot 72 is substantially linear and is spaced between and away from each of projection portion 92 of housing 12. In one example, no portion of base 20 maintained within base chamber 34 extends above a top of protruding structure 74 so as not to produce any undesirable secondary shadows as will be explained in additional detail below. In one embodiment, battery reception cavity 66 extends across a center line of bottom panel 30 with placement pegs 70 and protruding structure 74 being positioned on opposite sides of battery reception cavity 66.

Cover 22 is sized and shaped to cover base 20 in a manner substantially enclosing base chamber 34, that is, enclosing base chamber 34 other than aperture 46, opening 48, or other small access point through housing 12. In one embodiment, cover 22 includes a wall 80 arranged to define a cover chamber 84 and terminating in a free edge 82 adjacent an opening to cover chamber 84. Wall 80 is sized and shaped to form the remaining portion of an overall shape of housing 12 not formed by base 20. For example, as illustrated, wall 80 is conical in shape to define a top portion of a rocket ship. Wall 80, in another example, is formed of various segments, e.g., planar, curvilinear, etc. joined together.

Cover 22 defines an external coupling flange 86 immediately adjacent free edge 82 that is sized and shaped to fit around and mate with internal coupling flange 50. More specifically, external coupling flange 86 is radially offset from an internal surface 94 of wall 80. In this manner, when base 20 and cover 22 are coupled to one another, external coupling flange 86 fits just outside and surrounds internal coupling flange 50. In one embodiment, coupling protrusions 88 or other locking features extend from external coupling flange 86 radially inwardly to selectively interface with locking feature 52 (e.g., an L-shaped groove) defined along an external surface of internal coupling flange 50 of base 20. Initially, coupling protrusion 88 is aligned with an opening to a corresponding locking feature 52 along free edge 44 of base 20 and moved down into a top segment of locking feature 52.

Cover 22 is twisted or rotated relative to base 20 to slide coupling protrusion 88 into the bottom, that is, circumferentially extending, portion of the corresponding locking feature 52 to selectively couple or lock cover 22 in place relative to base 20. In this embodiment, cover 22 generally requires rotation relative to base 20 to be separated from base 20. In another embodiment, base 20 and cover 22 are alternatively or additionally adhered to one another such that base 20 and cover 22 are not readily uncouplable from each other. While cover 22 is described as having external coupling flange 86 and base 20 is described as having infernal coupling flange 50, in one example, that relationship is reversed and base includes an external coupling flange and cover 22 includes an internal coupling flange. Other coupling features and arrangements are also contemplated.

When cover 22 is coupled to base 20, chambers 34 and 84 are placed in communication with one another and collectively define a large chamber. In one example, chamber 84 remains empty unless projected object 16 extends into chamber 84. Assembled housing 12 includes a sidewall collectively formed by sidewall 32 of base 20 and wall 80 of cover 22.

Cover 22 may include a variety of other features including decorative features 90. Decorative features 90 generally are on and/or extend from an exterior surface 96 of wall 80 and provide additional aesthetic appeal and/or object identification of housing 12. For example, as illustrated, cover 22 includes decorative features 90 in the form of protrusions or rings serving to more readily identify housing 12 as being formed in a rocket ship shape.

In one example, both of electrical assembly 14 and object 16 are entirely supported and maintained on base 20, which simplifies construction. That is, the entire lamp 10 other than cover 22 is fully assembled with base 20 while base chamber 34 is open such that bottom panel 30 is readily accessible. Subsequently, cover 22 is placed thereon to place base chamber 34 in communication with cover chamber 84 and to enclose electrical assembly 14 and object 16 within housing 12.

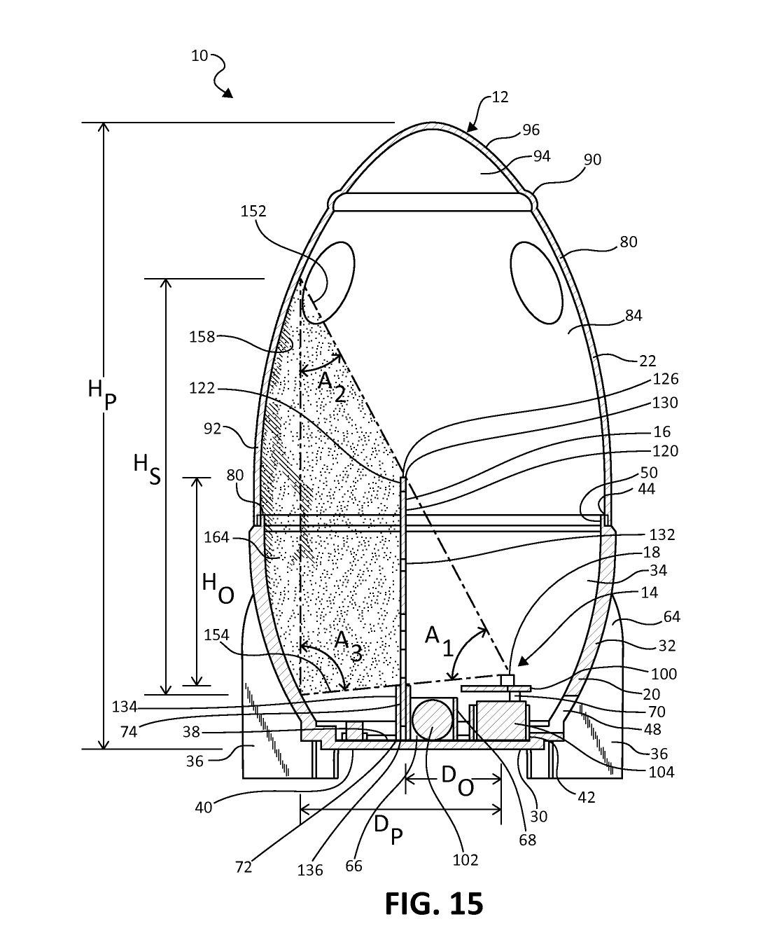

Housing 12 defines a projection surface 92 extending between a bottom and a top of housing 12 with a projection surface height H_{P} as indicated in FIG. 15. In one example, projection surface 92 is collectively formed by sidewall 32 of base 20 and wall 80 of cover 22. Projection surface 92 is spaced from and positioned on a side of protruding structure 74 opposite light source 18 of electrical assembly 14, for example, per the layout that will be further described below.

Additionally, referring to FIGS. 13 and 15, electrical assembly 13 is mounted on interior surface 38 of bottom panel 30. Electrical assembly 10, according to one embodiment, includes a printed circuit board (PCB) 100, a first power source 102, a second power source inlet 104, a variety of wires or connecting members 106, and an on/off switch 108 or other activation button. Various arrangements of electrical assembly 10 will be apparent upon reading this application. In one embodiment, light source 18 is electrically coupled with and supported by PCB 100. Wires 106 extend from PCB 100 to each of first power source 102, second power source inlet 104, and on/off switch 108 to electrically couple the components of electrical assembly 14 to one another. In one example, PCB 100 is mounted to housing 12 in a manner resting on one, two, three, or more placement pegs 70 such that light source 18 is sufficiently spaced from protruding structure 74. PCB 100 may be mounted in any suitable manner such as using an adhesive (not shown), fasteners, etc. In one example, PCB 100 is mounted to housing in a manner placing light source 18 at or above a height of protruding structure 74 relative to bottom panel 30.

First power source 102 may be any suitable power source fully maintained within housing 12. For example, first power source 102 is a direct current power source such as a battery, more particularly, in one instance, a single AA rechargeable or non-rechargeable battery, and fits within battery reception cavity 66 of base 20. Second power source inlet 104 is configured to selectively receive a power cord (not shown) to power electrical assembly 14 and/or charge first power source 102, and is generally of a standard type for conducting alternating current from an associated power outlet (not shown). In one example, any power cord is readily removable from lamp 10 while, in another embodiment, any power cord is generally permanently secured to lamp 10. While electrical assembly 14 is primarily described herein as including first power source 102 and second power source 104, in one example, electrical assembly 14 only includes one of first power source 102 and second power source 104.

On/off switch 108 provides means for user interaction with electrical assembly 14 to initiate illumination of light source 18 and/or to terminate illumination of light source 18. In one example, on/off switch 108 includes a button or a lever movable between an on position and an off position and extending through aperture 46 through bottom panel 30. In one example, on/off switch 108 is positioned on a side of protruding structure 74 opposite PCB 100 and is located closer to bottom panel 30 than a top edge of protruding structure 74.

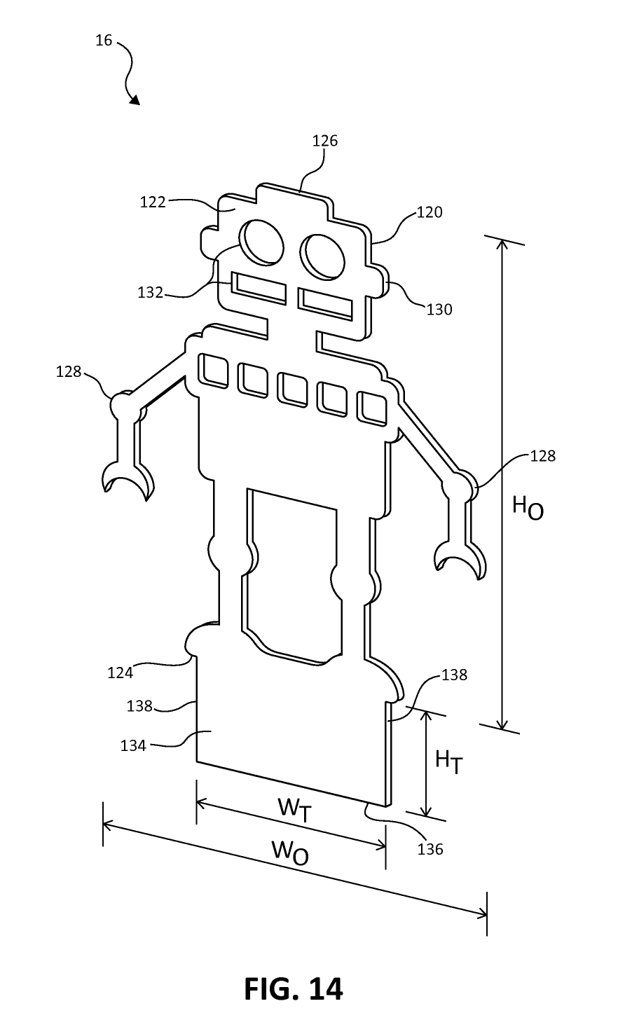

In one embodiment, projecting subject or object 16 is a substantially planar member defining a first surface 120 and a second surface 122 opposite first surface 120 as illustrated in FIG. 14. An exposed portion of object 16 extends between a bottom edge 124 and a topmost edge 126 to define an object height H_{O} and between opposing outermost side edges 128 to define an object width W_{O}. Object 16 defines an overall perimeter 130 in a desired shape of a shadow 158 to be projected on and through housing 12, as will be further described below. In one example, the shape of shadow 158 thematically corresponds with an overall shape of housing 12. For instance, where housing 12 is shaped as a rocket ship or other space related item, object 16 is shaped like a robot, alien, space traveler, or other shape likely to be found on such a vessel in nonfiction and/or fiction stories. Object height H_{O}, in one example, is less than a height H_{P} of projection surface 92, for example is equal to less than about thirty percent, and in one embodiment, less than about 20%, of height H_{P} of projection surface 92. In one embodiment, object 16 additionally includes apertures or cutouts 132 to further define object 16 as a particular character or other subject to be projected.

Referring to FIG. 14, in one example, object 16 includes a coupling tab 134 extending downwardly from bottom edge 124 to a bottom coupling tab edge 136. Coupling tab 134 has a width W_{T} defined between side edges 138 of coupling tab 134. In one example, coupling tab 134 defines width W_{T} that is less than a width W_{O} of object 16, for example, less than about 75% of width W_{O} of object 16. Width W_{T} is substantially equal to a width of objection reception slot 72 (see FIG. 13). In one example, coupling tab 134 has a thickness substantially equal to a thickness of object reception slot 72 such that coupling tab 134 frictionally is maintained in object reception slot 72 when lamp 10 is assembled as will be further described below.

Assembly of lamp 10 begins, in one embodiment, by placing electrical assembly 14 and object 16 in base chamber 34 of base 20 and securing the same to base 20. More particularly, coupling tab 134 of object 16 is pushed into object reception slot 72 as defined by protruding structure 74. In one embodiment, adhesive (not shown) is used to further secure coupling tab 134 in object reception slot 72 of protruding structure 74. In this manner, bottom edge 124 of object 16 is positioned to be substantially coextensive with a top edge of protruding structure 74. A remainder of object 16, that is the portion of object 16 extending from bottom edge 124 to top edge 126, extends above and upwardly from protruding structure 74. In one embodiment, protruding structure 74, and therefore, object 16, is not centered within base chamber 34, or relative to base 20 as a whole, in a direction transverse to its longitudinal extension within chamber 34. For instance, protruding structure 74 is positioned nearer projection surface 92 than a surface of housing on an opposite side of base chamber 34.

In one example, first power source 102 is placed in battery reception cavity 66, which is on one side of and adjacent protruding structure 74. PCB 100, with light source 18 mounted thereon, is coupled to base 20 via placement pegs 70 on the same side of protruding structure 74 as battery reception cavity 66. In particular, PCB 100 is mounted to base 20, e.g., using adhesive and/or friction fit, in a manner positioning light source 18 a distance D_{O} from object 16 selected to form a shadow 158 on projection surface 92 having a height H_{S} that is equal to at least about 60% a height H_{P} of projection surface 92, and in one example of housing 12, for instance, equal to at least about 70% height H_{P} of projection surface 92 as illustrated in FIG. 15.

Second power source inlet 104 is positioned and secured within base chamber 34 to align with opening 48 in base 20 such that a power cord (not shown) is able to pass through opening 48 to electrically couple with second power source inlet 104. In one example, second power source inlet 104 is positioned between placement pegs 70 below PCB 100. On/off switch 108 is positioned to extend through aperture 46 such that a user interacts with electrical assembly 14 via on/off switch 108. In one example, no internal features of base 20 extend higher above bottom panel 30 than protruding structure 74 extends above bottom panel 30. Light source 18 is positioned at a height above bottom panel equal to or slightly higher than a top of protruding structure 74 such that any shadow 158, which is created as some of light rays from light source 18 are directed toward projection surface 90 and blocked by object 16, is not generally obscured by shadows, etc. from other components within housing 12.

The layout of components within base chamber 34 is more specifically selected to form shadow 158 with a size configured to take up much of projection surface 92, for example, at least about sixty percent of height H_{P} of projection surface 92. For such determination, in one example, light source 18 is considered to function as a point light source such that an umbra 164 (see shaded portion of FIG. 15) is formed where light from light source 18 is blocked by object 16, that is between top and bottom boundary lines 152 and 154, respectively. In this manner, a crisp and/or sharply defined shadow 158 is cast on projection surface 92 of housing 12 with substantially no penumbra. Due to the material used for housing 12, shadow 158 is visible through housing 12 as dark area 160, for example as illustrated in FIGS. 7-12, when light source 18 is illuminated.

In one example, where a desired height H_{S} and placement of shadow 158 is known, light source 18 is positioned at a convergence of a top boundary line 152, which linearly extends from a top point of shadow 158 and intersects top edge 126 of object, and of a bottom boundary line 154, which linearly extends from a bottom point of shadow 158 and extends through bottom edge 124 of object 16. In this manner, a triangle is defined between a top point of shadow 158, a bottom point of shadow 158, and light source 18. In this relationship, height H_{S} of shadow 158 is equal to a distance between top point of shadow 158 and light source 18 (that is, a length of top boundary line 152) multiplied by the sine of angle A₁ of the triangle adjacent light source 18 and divided by the sine of the angle A₃ of the triangle adjacent the bottom most point of shadow 158. Similarly, in this relationship, height H_{S} of shadow 158 is also equal to a distance between the bottom point of shadow 158 and light source 18 (that is, a length of bottom boundary line 154) multiplied by the sine of angle A₁ of the triangle adjacent light source 18 and divided by the sine of the angle A₂ of the triangle adjacent the top point of shadow 158.

In one embodiment, an entirety of housing 12 is formed of a single material. For example, a single material is used to form housing 12 via injection or otherwise molding base 20 and cover 22. The material used to form housing 12 is sufficiently translucent such that light from light source 18 is visible therethrough yet sufficiently opaque to hide electrical assembly 14 and object 16 from view through housing 12 when light source 18 is turned off. In this manner, shadow 158 results in a corresponding dark region 160 as viewed through an outer surface of housing 12 surrounded by light regions 162. In one example, the material used to form housing 12 has sufficient opacity such that only housing 12 and not internally maintained components thereof are visible through housing 12 when light source 18 is not illuminated, that is, when light source 18 is turned off (see FIGS. 1-6). In the illustrated embodiment, shadow 158 caused by light directed toward object 16 is selectively visible through housing 12 when lamp 10 is powered on to illuminate light source 18 and is eliminated when lamp 10 is powered off. In one example, object 16 is sized and shaped so shadow 158 appears to be thematically related to a shape of housing 12, such as appearing as a subject that would be somewhat expected to be found within a vessel having a shape similar to housing 12. The image collectively defined by housing 12 and object 16 (that is, shadow 158 caused by object 16) when housing 12 is illuminated is generally configured to be aesthetically pleasing, comical, informative, and/or otherwise interesting to observers thereof. Lamp 10 also functions as a source of light to dimly illuminate a room while providing aesthetic and artistic appeal to the user.

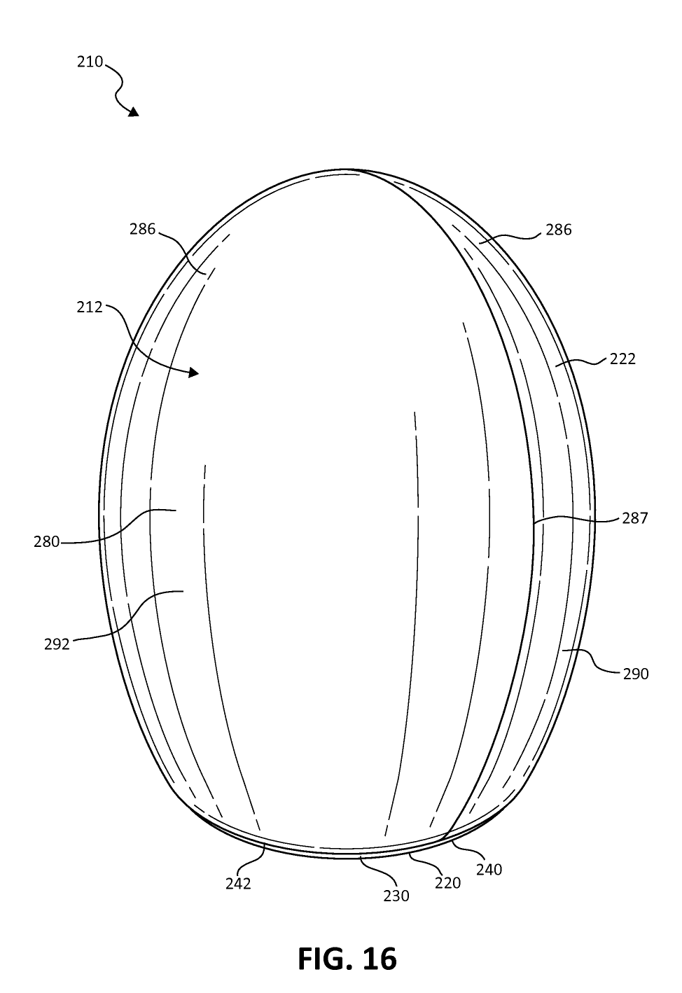

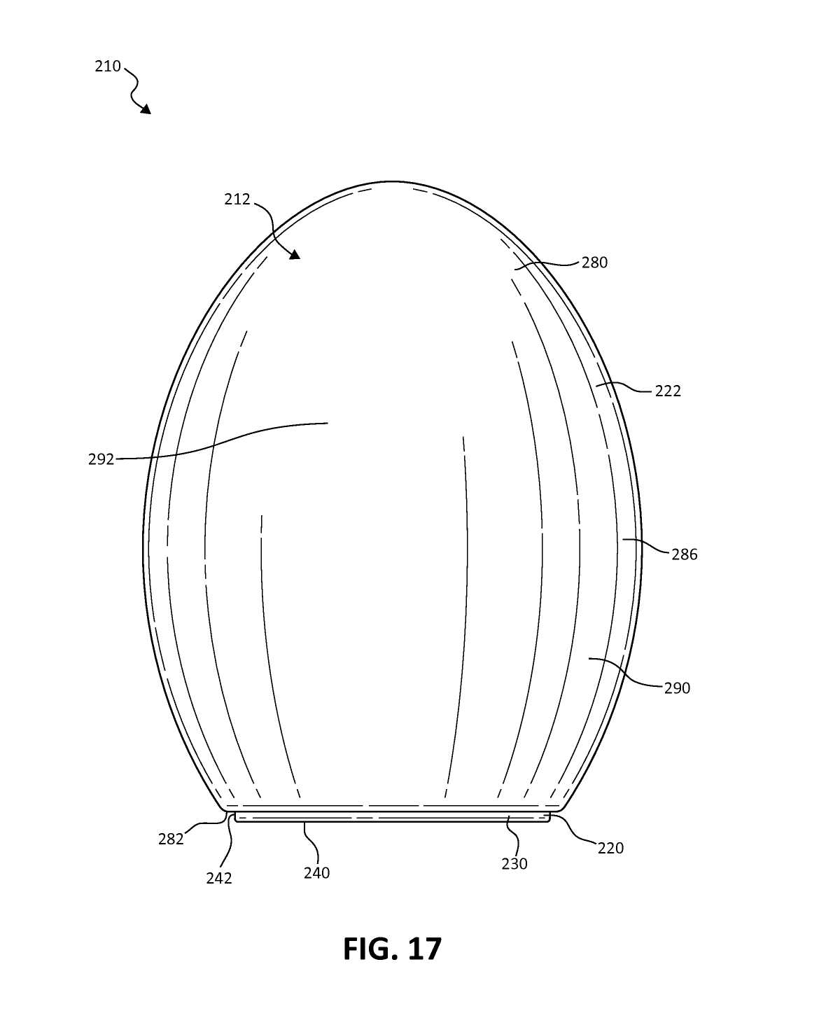

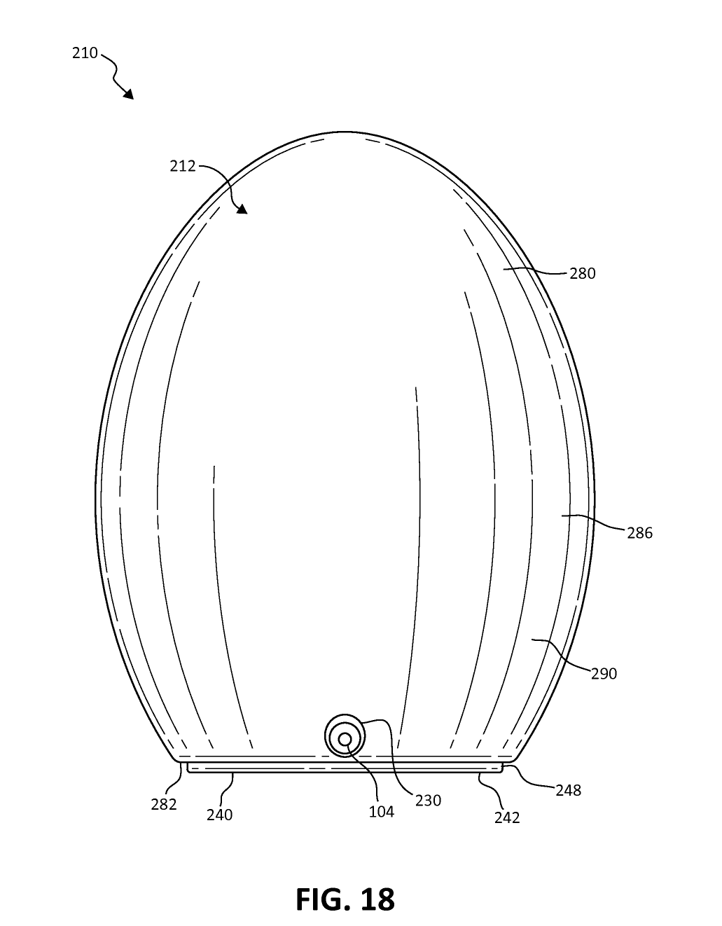

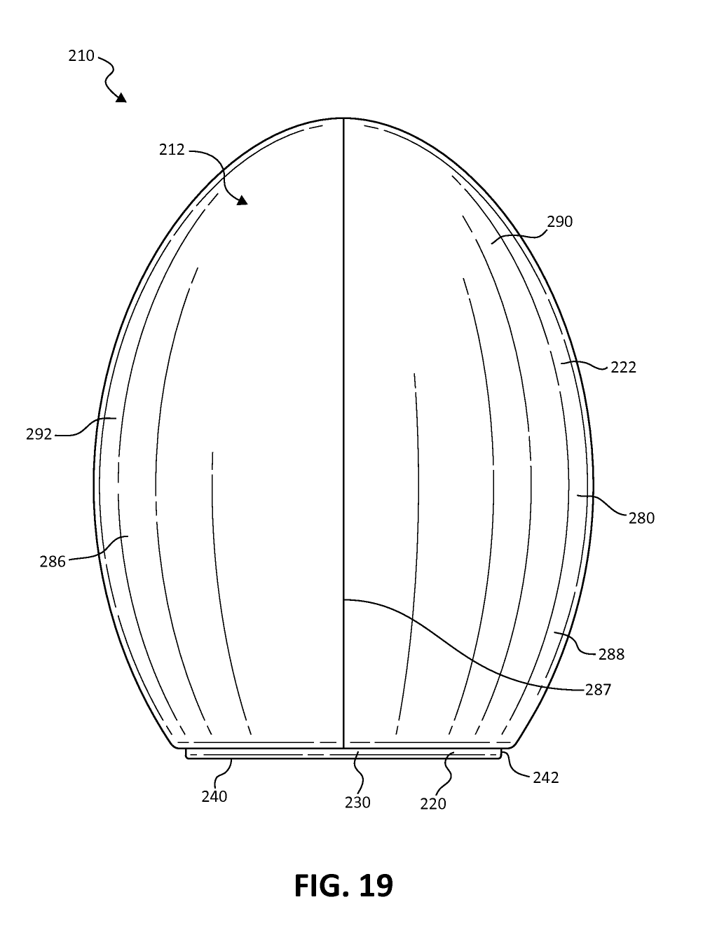

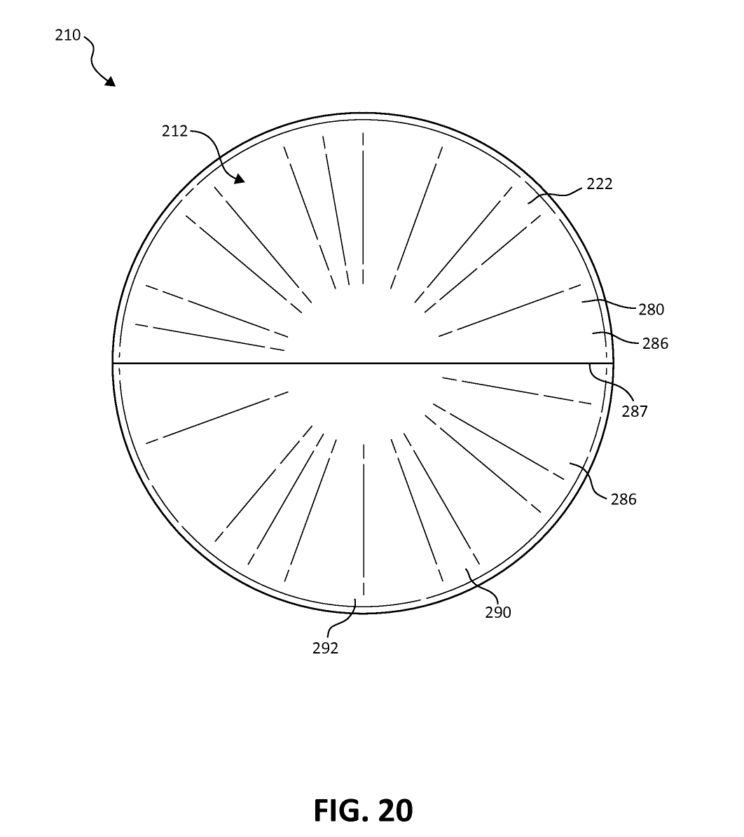

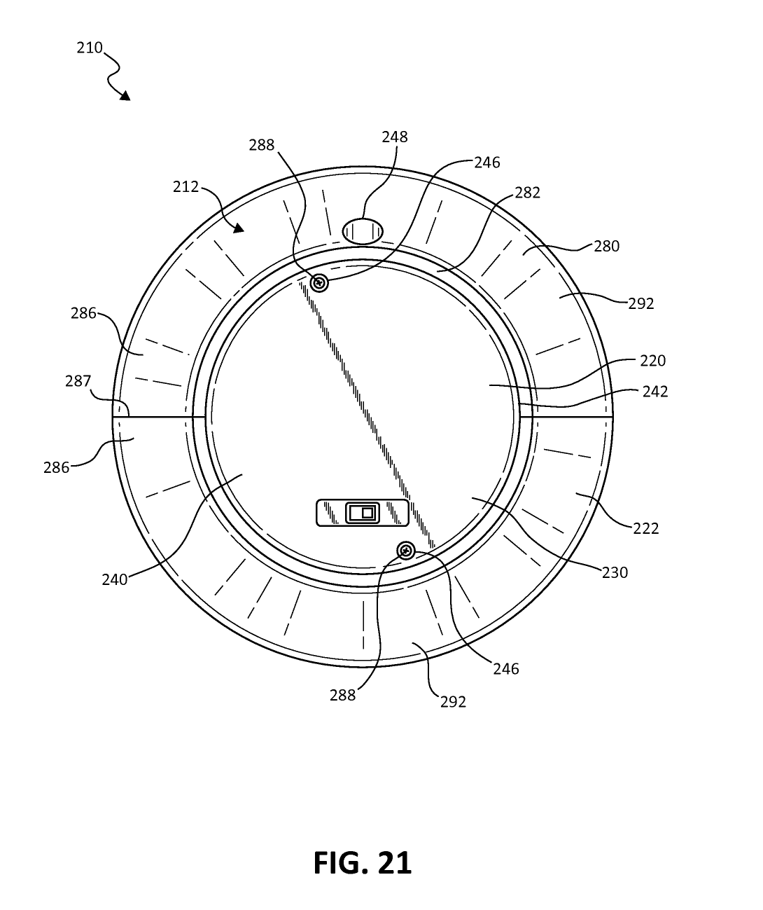

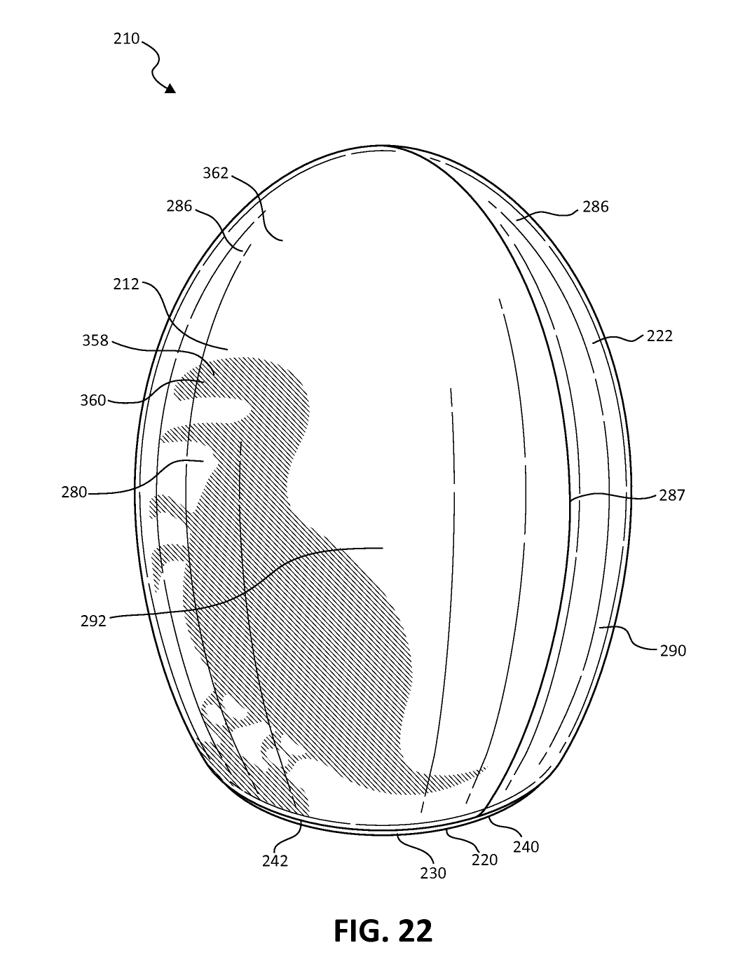

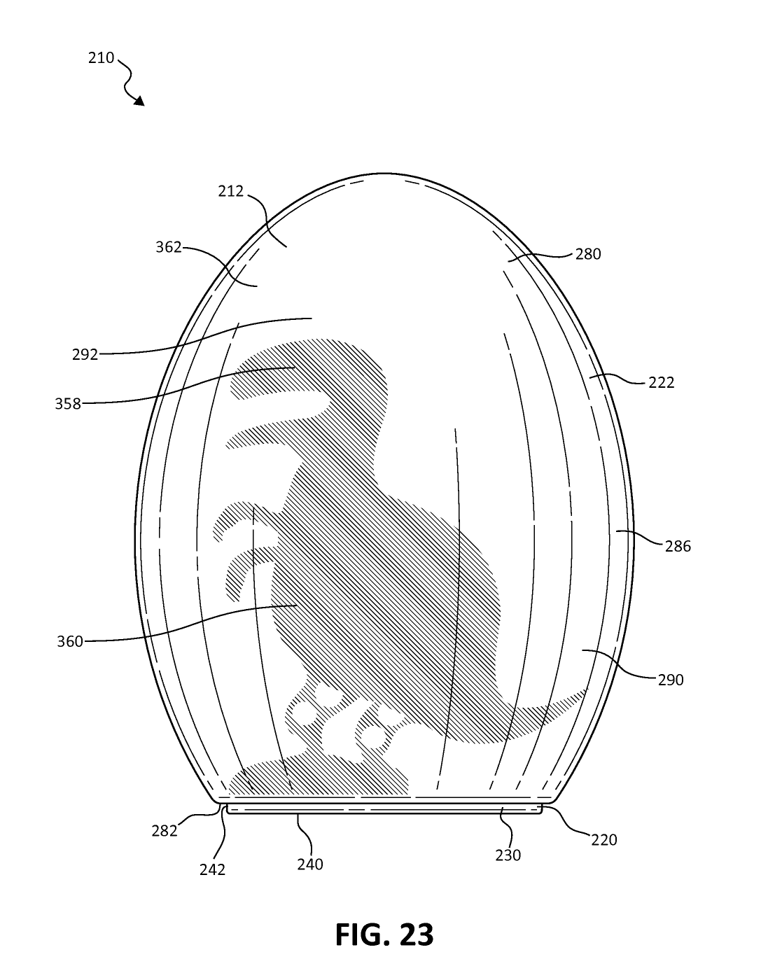

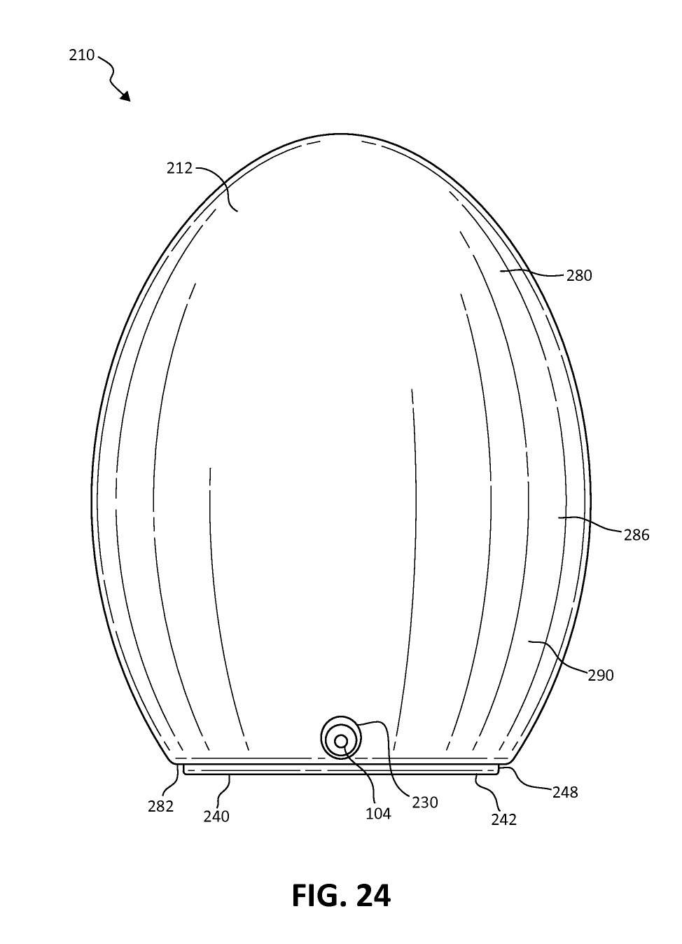

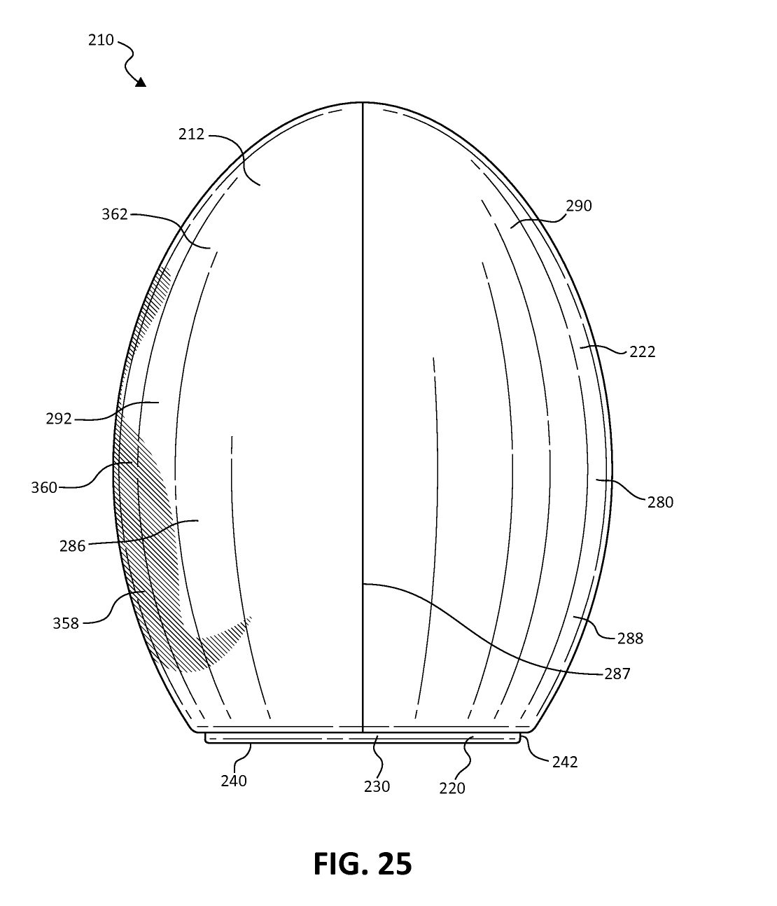

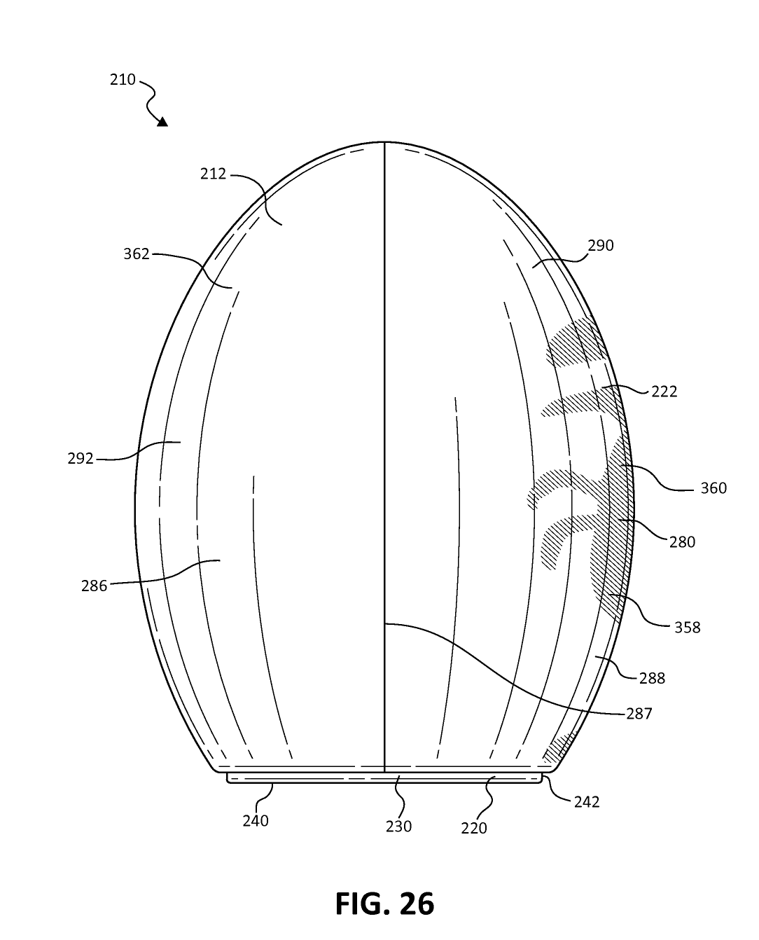

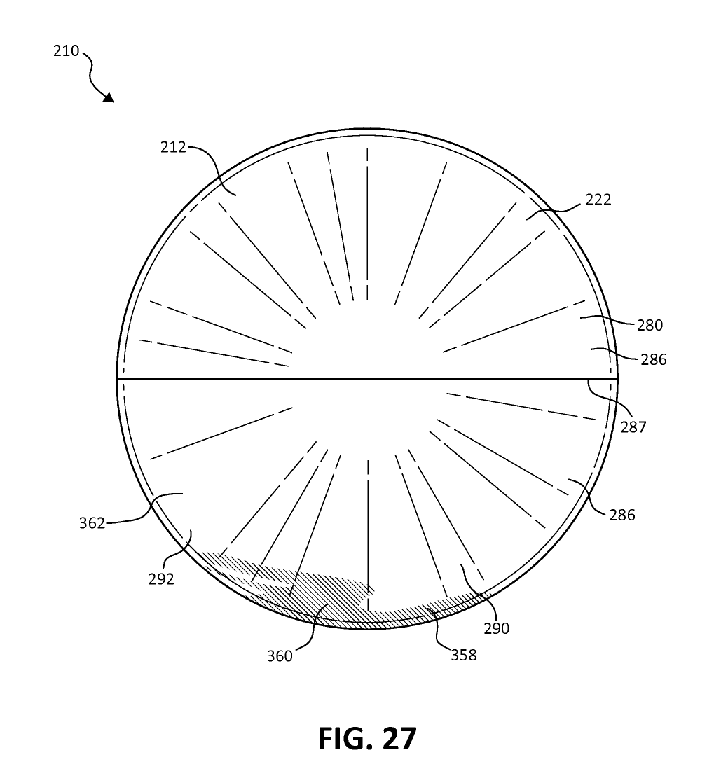

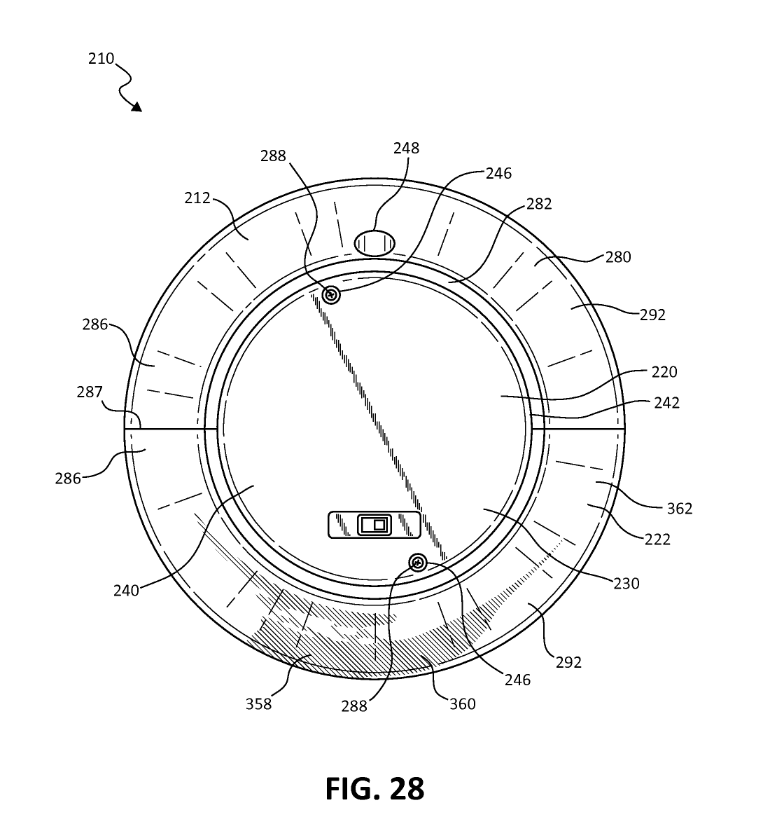

FIGS. 16-28 illustrate another embodiment of a lamp at 210, with FIGS. 16-21 showing lamp 210 in the off or non-illuminated state and FIG. 22-28 showing lamp 210 in the on or illuminated state. Lamp 210 includes housing 212 comprising a base or first member 220 and a cover or second member 222 accordingly to one example. Base 220 includes, a planar bottom panel 230 having an exterior surface 240. In one embodiment, bottom panel 230 includes a perimeter edge 242 for abutting cover 222 and is coupled with cover 222 and/or components therein via apertures 244 for receiving screws or other fasteners 288. A switch aperture 246 is formed through bottom panel 230 to provide access to any power switch in a similar manner as described above for lamp 10 (FIGS. 1-15).

Cover 222 is formed of two or more pieces 286 joined together along a substantially vertically extending boundary line 287, according to one embodiment of the invention. In one embodiment, cover 222 is formed as a single piece. Cover 222 includes sidewall 280 and a bottom panel 282, for example, each collectively defined by the two or more pieces 286, defining a chamber (not shown) therein. Sidewall 280 may be formed in any suitable shape such that housing 12 appears in a desired size and shape, for example, in a shape of an egg as illustrated. Bottom panel 282 extends substantially horizontally to a support surface of lamp 210. Fasteners 288 extend through apertures 244 of base 220 and into bottom panel 282 of cover 22 to at least partially secure base 220 and cover 222. In one example, cover 22 includes decorative features 290 or surfaces contributing to the overall representation of an object by housing 210.

Like lamp 10, housing 12 of lamp 210 includes a similar electrical assembly (not shown) with object for projection, for instance, shaped as a dinosaur or other item corresponding with an overall shape of housing 12. In one example, base 220 does not independently form a partially enclosed chamber (not shown), but rather has an electrical assembly (not shown), similar to electrical assembly 14 other than a shape of the subject for projection, mounted thereon. In this embodiment, cover 222 independently forms the chamber for enclosing the electrical assembly, open at a bottom thereof for receiving bottom panel 230 of base 20 in a such a manner that the electrical assembly and subject of lamp 210 extend from bottom panel 230 into the chamber defined by cover 222.

Housing 12 defines a projection surface 292 through which a shadow 358 of an internal object (not shown) is presented as a dark region 360 surrounded by light regions 362 as illustrated in FIGS. 22-28. In one example, sidewall 280 includes an opening 248 for allowing a power cord to extend from electrical assembly, such as from a second power source inlet 104, out of housing 212. Many other shapes and variations of lamps, housing shapes, and object shapes are also contemplated as will be apparent to those of skill in the art upon reading this application, to provide users with light for a room in an aesthetically pleasing and somewhat surprising or entertaining manner, that is, via an object projection which appears to disappear and reappear when the associated lamps are turned on and off.

Although the invention has been described with respect to particular embodiments, such embodiments are meant for the purposes of illustrating examples only and should not be considered to limit the invention or the application and uses of the invention. Various alternatives, modifications, and changes will be apparent to those of ordinary skill in the art upon reading this application. Furthermore, there is no intention to be bound by any theory presented in the preceding background of the invention or the above detailed description.

What is claimed is:

1. A lamp comprising:
a housing includes a bottom panel and a sidewall extending upwardly away from the bottom panel to collectively define a chamber substantially enclosed within the housing, wherein the sidewall includes a projection portion extending away from the bottom panel and having a first height;
an object statically coupled to and extending upwardly from the bottom panel, wherein the object is spaced from the projection portion of the sidewall and is enclosed within the chamber; and
an electrical assembly mounted on the bottom panel and maintained within the chamber, wherein the electrical assembly includes a light source positioned on a side of the object opposite the projection portion of the sidewall, wherein:
when the light source is illuminated, light rays from the light source are directed toward the projection portion of the sidewall, and a portion of the light rays are blocked by the object creating a shadow on the projection portion of the sidewall, and
the shadow is visible through the sidewall when viewing the lamp from a location external to the chamber.

2. The lamp of claim 1, wherein the object is substantially planar and has a perimeter shape of a recognizable figure.

3. The lamp of claim 2, wherein the object defines a coupling tab extending downwardly from a remainder of the object and the perimeter shape of the recognizable figure, the housing includes a protrusion extending upwardly from the bottom panel and defining an object reception slot, and the coupling tab snugly fits within the object reception slot to at least partially secure the object to the bottom panel.

4. The lamp of claim 1, wherein, other than the housing, the object is the only lamp component that extends to a position further away from the bottom panel than the light source.

5. The lamp of claim 1, wherein the object has an object height, and the shadow has a shadow height that is equal to at least about double the object height.

6. The lamp of claim 5, wherein the projection portion of the sidewall has a projection portion height, and the shadow height is equal to at least about 60% of the projection portion height.

7. The lamp of claim 1, wherein the light source is a single light emitting diode.

8. The lamp of claim 1, wherein the housing is formed of a single material having an opacity such that the object is not viewable through the sidewall and the shadow is viewable through the sidewall when the light source is illuminated.

9. The lamp of claim 1, wherein the electrical assembly and the object is solely mounted to the sidewall of the housing via the bottom panel.

10. The lamp of claim 9, wherein the bottom panel is substantially planar and defines an internal surface and an external surface that is opposite the internal surface, the internal surface supports the electrical assembly, and the external surface provides a bottommost surface of the housing for interfacing with a supporting surface.

11. The lamp of claim 1, wherein the object defines a coupling tab extending downwardly from a remainder of the object, the housing includes a protrusion extending upwardly from the bottom panel and defining an object reception slot, and the coupling tab snugly fits within the object reception slot to at least partially secure the object to the bottom panel.

12. The lamp of claim 1, wherein the light source is statically secured within the housing.

13. The lamp of claim 12, wherein the object is positioned closer to the light source than to the projection portion of the sidewall.

14. The lamp of claim 1, wherein the object is shaped as a character and the housing is shaped as an enclosure for the character, and the enclosure and the character are visually linked thematically.

15. The lamp of claim 1, wherein the housing is shaped like a spaceship, and the object is shaped like one of a robot, an alien, and a space traveler.

16. A light assembly comprising:
an enclosure defining a bottom panel and forming an open chamber within the enclosure, wherein the enclosure defines a coupling feature extending upwardly from the bottom panel within the open chamber;
a substantially planar object coupled to the bottom panel via the coupling feature, wherein a portion of the substantially planar object extending beyond the coupling feature is unsupported within the open chamber;
an electrical assembly mounted to the enclosure and positioned within the open chamber, wherein:
the electrical assembly includes a light source, which, when illuminated, emits light rays toward the substantially planar object such that a portion of the light rays are blocked from reaching a projection portion of the enclosure on an opposite side of the object as compared to the light source creating a shadow on the enclosure visible from outside the enclosure, and
other than the enclosure, the substantially planar object is the only component of the light assembly extending within the open chamber above the light source.

17. The light assembly of claim 16, wherein the shadow has a height equal to at least 60% of a height of the enclosure.

18. The light assembly of claim 16, wherein the substantially planar object includes a coupling tab maintained within a slot of the coupling feature to couple the substantially planar object to the enclosure.

19. The light assembly of claim 16, wherein the light source is a single point light source.

20. The light assembly of claim 16, wherein the projection portion of the enclosure is a curved surface of the enclosure.
